(19) United States
(12) Patent Application Publication
(10) Pub. No.: US 2024/0116164 A1
(43) Pub. Date: Apr. 11, 2024

(54) WINDSHIELD REMOVAL METHOD AND TOOL

(71) Applicant: Cory Avary, Odessa, TX (US)

(72) Inventor: Cory Avary, Odessa, TX (US)

(21) Appl. No.: 17/962,522

(22) Filed: Oct. 9, 2022

(51) Int. Cl. B25F 5/02; B25B 27/00

(52) U.S. Cl. CPC B25F 5/02; B25B 27/0035

(57) ABSTRACT

An improved windshield extractor tool is provided. The tool can be made by modifying a reciprocating tool such as a saw, to produce an extractor tool with a quick disconnect assembly. The attachment assembly of the existing reciprocating tool is removed leaving only a cylindrical or rectangular rod connected to the motivating assembly of the tool. A quick disconnect hub is then attached, as by welding, to the remaining rod. The specialized extractor knife is modified for locking engagement with the hub so that the knife can be removed and attached in a single motion. The hexagonal hub allows for rotation of the knife to one of six discrete positions, enabling the operator to re-orient the knife in accordance with the contours of the windshield edges.

### BACKGROUND OF THE INVENTION

### 1. Field of the Invention

The present invention relates to specialized tools for repairing automobiles. More specifically, the invention relates to an improved windshield extractor tool.

### 2. Description of the Prior Art

This invention relates to methods and devices for removing a windshield from an automobile, and in particular to a powered reciprocating device for effectively cutting the sealant employed to secure the windshield in place.

In current automobile manufacturing practice the windshield is affixed to the automobile by being placed between the interior body portion of the automobile and an exterior molding, with a tough, reliable sealant, usually a urethane formulation, adhesively securing the windshield in place. To remove a windshield from an automobile, which is necessary when a windshield has been damaged or is to be recovered as salvage, this tough sealant material must be efficiently cut through to effect a clean removal of the windshield from the vehicle.

It is known in the prior art to modify a reciprocating tool by attaching a specially shaped knife, the knife reciprocating at a high speed to effect cutting and removal of the rubberized surround of the windshield. These modified tools suffer from a number of drawbacks.

First, the assembly for attaching the knife is complex, and is formed of several parts. Secondly, because of the complicated assembly, removal and re-attachment of the knife is difficult and time consuming. Third, the attachment assembly, due to its structure is highly prone to failure over time due to the energetic motion of the reciprocating assembly. Finally, the typical prior art attachment assembly includes a sheath between which the knife end is placed, the sheath assembly requiring a pass through connector, with the resulting assembly highly susceptible to failure over time.

In accordance with the above, an improved windshield extractor tool is provided. The tool can be made by modifying a reciprocating tool such as a saw, to produce an extractor tool with a quick disconnect assembly. The attachment assembly of the existing reciprocating tool is removed leaving only a cylindrical or rectangular rod connected to the motivating assembly of the tool. A quick disconnect hub is then attached, as by welding, to the remaining rod. The specialized extractor knife is modified for locking engagement with the hub so that the knife can be removed and attached in a single motion. The hexagonal hub allows for rotation of the knife to one of six discrete positions, enabling the operator to re-orient the knife in accordance with the contours of the windshield edges.

### SUMMARY OF THE INVENTION

It is a major object of the invention to provide an improved windshield extractor tool.

It is another object of the invention to provide an improved windshield extractor tool from a modified reciprocating tool.

It is another object of the invention to provide an improved windshield extractor tool having a quick disconnect assembly.

It is another object of the invention to provide an improved windshield extractor tool which is highly reliable.

It is another object of the invention to provide an improved windshield extractor tool having a cutting knife that can be variably oriented.

### BRIEF DESCRIPTION OF THE DRAWINGS

Various other objects, features, and attendant advantages of the present invention will become more fully appreciated as the same becomes better understood when considered with the accompanying drawings, in which like reference characters designate the same or similar parts throughout the several views, and wherein:

FIG. 1 shows a side sectional view of the windshield removal tool of the invention.

FIG. 2 shows a top plan view of a knife to be used with the windshield removal tool of the invention.

FIG. 3A shows a top plan view of second embodiment of a knife to be used with the windshield removal tool of the invention.

FIG. 3B shows a top plan view of third embodiment of a knife to be used with the windshield removal tool of the invention.

FIG. 3C shows a top plan view of fourth embodiment of a knife to be used with the windshield removal tool of the invention.

FIG. 3D shows a top plan view of fifth embodiment of a knife to be used with the windshield removal tool of the invention.

FIG. 3E shows a top plan view of sixth embodiment of a knife to be used with the windshield removal tool of the invention.

FIG. 4 shows a front view of the knife and connector the windshield removal tool of the invention illustrating orientation options.

### DETAILED DESCRIPTION OF THE PREFERRED EMBODIMENTS

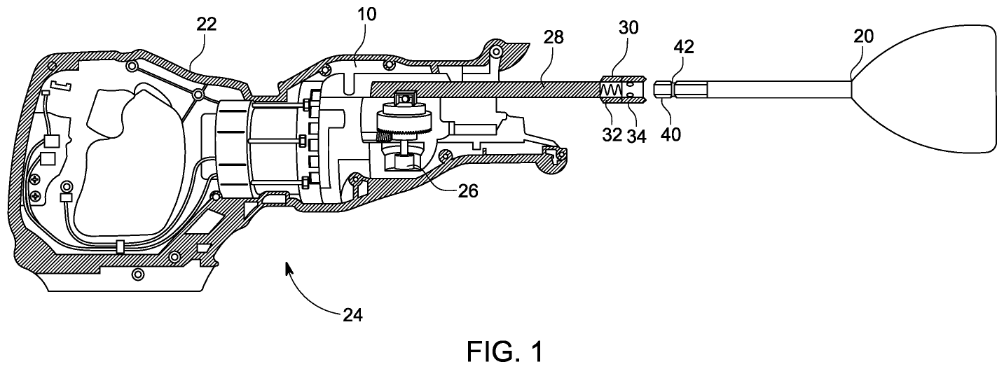

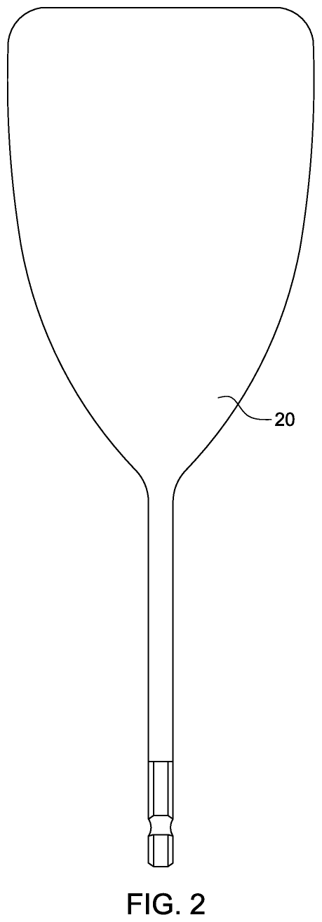

Referring now to FIGS. 1-4, the tool of the invention is shown. The tool has two main components, the drive portion 10 and the knife portion 20. The drive portion 10 may be a reciprocating saw such as a Sawzall® saw, or a glass cut out tool such as a DeWalt® GT-.357, modified in accordance with the method of the invention.

The drive portion 10 has a main body comprising a housing 22 with a motor 24 and mechanical linkage 26 for causing reciprocating motion of a rod 28 having connecting means for connecting to the knife 20. Conventional extraction tools have a sheath assembly for sandwiching the extraction knife, the assembly typically having a pass through connector such as a rod or bolt. These tools take a while to connect and disconnect and have a high failure rate due to the sheath assembly being subject to constant high energy force. In accordance with the invention, the sheath assembly is removed and a quick disconnect hexagonal socket assembly 30 is welded in place onto the rod 28 as seen in FIG. 1. The socket assembly 30 includes a spring assembly 32 which is biased to push the connecting end of the knife 20 outward, with a pair of sprung ball bearings 34, whereby insertion of the connecting end 40 of the knife 20 pushes spring assembly inward until the groove 42 at the connecting end 40 reaches the ball bearing 34 and “snaps” in place in the well known manner.

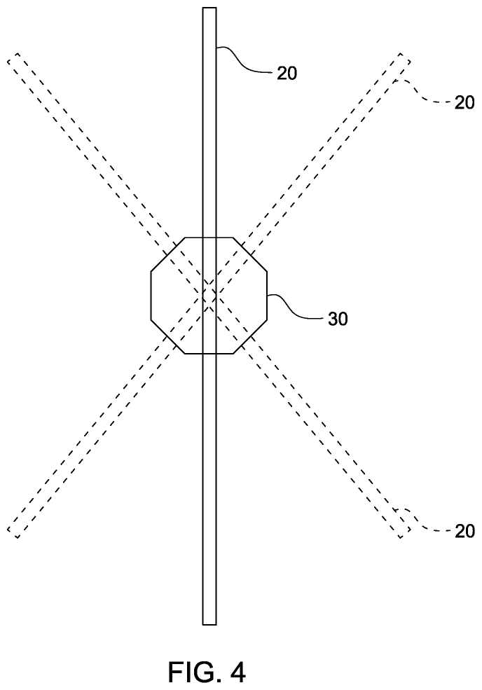

The connecting end 40 of the knife 20 is modified to have a hexagonal cross section corresponding to the socket 30 so that once the end 40 is inserted and locked in place relative rotation between socket 30 and end 40 is impossible. Thus, in operation, a user simply inserts connecting end 40 of the knife 20 into socket 30 until it securely snaps in place, with removal effected using the reverse motion. As shown in FIG. 1, the knife 20 is vertically oriented, that is the knife edge 20 is oriented at a zero degree angle from the plane parallel to the side of the body 22 of the tool. This orientation can be problematic when dealing with curved or contoured windshield edges which constantly cause the operator to angle the tool for optimal cutting. Accordingly, the operator can remove the knife 20 and orient into the several positions as shown in FIG. 4. As the tool is of a quick connect/disconnect design, this process takes mere seconds, so that the operator can switch orientation rapidly to reduce the overall cutting time.

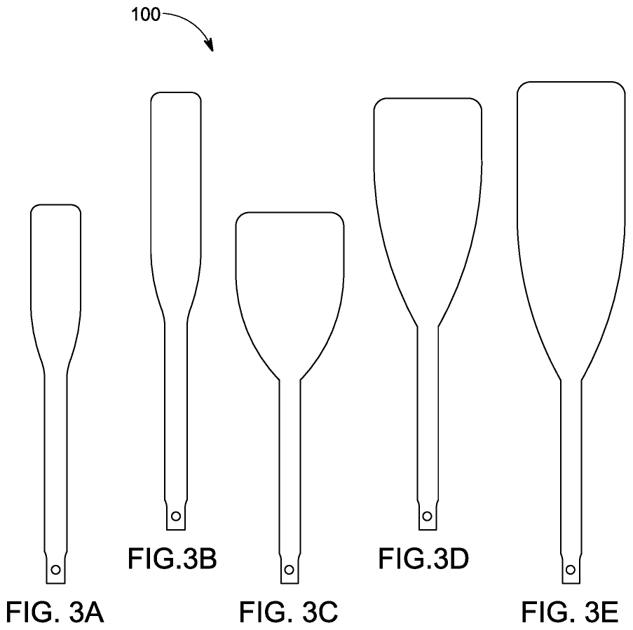

As shown in FIG. 3, there are several knife options available. The knives 100 are of varying shapes and sizes, giving the operator a wide variety of orientation and sizing options when using the tool, the options quickly facilitated by way of the quick disconnect method as described above.

From the foregoing description, one skilled in the art can easily ascertain the essential characteristics of this invention and, without departing from the spirit and scope thereof, can make various changes and modifications of the invention to adapt it to various usages and conditions.

It is to be understood that the present invention is not limited to the sole embodiment described above, but encompasses any and all embodiments within the scope of the following claims:

1. A method of forming an improved windshield extractor tool from an existing reciprocating tool, comprising the steps of:
removing an existing connection assembly from a reciprocating rod (28) of the reciprocating tool, wherein the reciprocating tool includes a body (22) having a side;
wherein the improvement comprises:
welding an end portion of a quick disconnect socket assembly (30) having opposite end portions onto said rod (28), wherein an opposite end portion of the socket assembly (30) defines a cavity hexagonal in cross section; and
forming a connecting end (40) on an extracting knife (20) having an edge, wherein said connecting end (40) is defines an external hexagonal cross section adapted and configured for insertion into said socket assembly (30) in a non-rotational manner, and wherein a first orientation of the connecting rod (40) when connected to the socket assembly (30 results in the knife edge being spaced from and oriented at a zero degree angle relative to a plane oriented parallel to the side of the body (22), and wherein a second orientation of the connecting rod (40) when connected to the socket assembly (30) results in the knife edge being spaced from and oriented at an acute angle relative to the plane.

2. A method of forming an improved windshield extractor tool from an existing reciprocating tool, wherein the improved windshield extractor tool is used for removing a windshield having edges from a vehicle, comprising the steps of:
removing an existing connection assembly from a reciprocating rod (28) of the reciprocating tool, wherein the reciprocating tool includes a body (22) having a side;
wherein the improvement comprises:
welding an end portion of a quick disconnect socket assembly (30) having opposite end portions onto an end portion of the rod (28), wherein said end portion of the rod (28) is spaced from the body (22), wherein an opposite end portion of the socket assembly (30) defines a cavity hexagonal in cross section;
forming a connecting end (40) on an extracting knife (20) having an edge, wherein the connecting end (40) defines an external hexagonal cross section adapted and configured for secure insertion into the socket assembly (30) in a non-rotational manner and for removal therefrom, and wherein a first orientation of the connecting rod (40) when connected to the socket assembly (30) results in the knife edge being spaced from and oriented at a zero degree angle relative to a plane oriented parallel to the side of the body (22), and wherein a second orientation of the connecting rod 40) when connected to the socket assembly (30) results in the knife edge being spaced from and oriented at an acute angle relative to the plane; and
re-orienting the knife (20) in accordance with contours of the windshield edges, for causing the improved windshield extractor tool to remove the windshield from the vehicle.
